(19) United States
(12) Patent Application Publication
(10) Pub. No.: US 2003/0231100 A1
(43) Pub. Date: Dec. 18, 2003

(54) Vehicular burglarproof device

(76) Inventor: Jin-Sang Chung, Gyeonggi-do (KR)

Correspondence Address: Pennie & Edmonds, LLP, 3300 Hillview Avenue, Palo Alto, CA, 94304, US

(21) Appl. No.: 10/329,237

(22) Filed: Dec. 23, 2002

(30) Foreign Application Priority Data
Jun. 18, 2002 (KR) 2002-34046

(51) Int. Cl. H04Q 1/00

(52) U.S. Cl. 340/5.2; 307/10.5

(57) ABSTRACT

The invention relates to a vehicular burglarproof device. The device determines whether a vehicle is used by an authorized driver through wireless communication between an identification information unit of a fob and an electronic control unit installed inside the vehicle. The device provides for the starting of the engine and unlocking the steering operations without the separate step of inserting a key.

### FIELD OF THE INVENTION

The present invention relates to a burglarproof device for a vehicle. More particularly, the present invention relates to a burglarproof device that prevents intruders from starting or steering a vehicle.

### BACKGROUND OF THE INVENTION

Conventionally, vehicle burglarproof devices are mechanical locking devices installed near a vehicle door and steering column. The typical locking device is made to start the engine of a vehicle and to unlock the steering shaft simultaneously when a driver inserts and turns a key. However, a drawback in the typical mechanical locking device is that a driver must possess and insert a key to unlock the steering shaft and start the engine. Also, a burglar can steal a vehicle by breaking the mechanical locking device and starting the engine through simple manipulations.

### SUMMARY OF THE INVENTION

Embodiments of the present invention provide a potentially burglarproof device that improves the burglarproof function of a vehicle by determining whether a vehicle is used by an authorized driver. The determination is done through a wireless communication between an identification information unit of a fob and an electronic control unit (ECU) installed inside the vehicle. This allows the engine to be started and the steering wheel to be manipulated without the separate step of inserting a key. Furthermore, the normal starting operations are controlled through communication with the ECU.

In accordance with a preferred embodiment of the present invention, a vehicular burglarproof device comprises a fob containing identification information to release the ignition and steering locks of the vehicle. A locking device for switching between an unlocked and locked position of the ignition and steering column. A personal identification card (PIC) unit for determining whether the driver is an authorized user of the vehicle. The PIC communicates with the fob and the control locking unit, thereby allowing starting and/or unlocking of the steering column. A body control module (BCM) is also included that provides a signal to start the vehicle to an engine electronic control unit according to the signal of the PIC unit.

### BRIEF DESCRIPTION OF THE DRAWINGS

For a fuller understanding of the nature and objects of the present invention, reference should be made to the following detailed description taken in conjunction with the accompanying drawings in which:

FIG. 1 is a structural view of an embodiment of a locking device for a vehicle according to an embodiment of the present invention;

FIG. 2 shows an operational state of a vehicular burglarproof device of an embodiment of the present invention;

FIG. 3 shows an emergent operational state of a vehicular burglarproof device of an embodiment of the present invention;

FIG. 4 is a perspective view of an embodiment of a locking unit of a vehicle burglarproof device installed on the vehicle according to an embodiment of the present invention;

FIG. 5 is a front view showing a locking unit of a burglarproof device of an embodiment of the present invention;

FIG. 6 is a cross-sectional view for a cross-section taken along the line VI-VI of FIG. 5;

FIG. 7 is a perspective view showing an assembled state of the internal parts of an embodiment of the locking unit shown in FIG. 5;

FIG. 8 is a left lateral view of the locking unit shown in FIG. 5;

FIG. 9 is a cross-sectional view illustrating a cross-section taken along the line IX-IX shown in FIG. 8;

FIG. 10 is a perspective view illustrating a housing of an embodiment of the locking unit of the present invention;

FIG. 11 is a perspective view illustrating an actuator in an embodiment of the present invention prior to a plunger being assembled within the actuator;

FIG. 12 is a cross-sectional view illustrating a cross-section taken along the line XII-XII of FIG. 5;

FIG. 13 is a perspective view illustrating a cam shaft and slider in contact according to an embodiment of the present invention;

FIG. 14 is a perspective view illustrating the connection state of a park lock rotator and park lock slider of a gear change lever according to an embodiment of the present invention;

FIG. 15 is a perspective view illustrating the orientation between a parking lock rotator and park lock slider when a gear change lever is set to the park range according to an embodiment of the present invention;

FIG. 16 shows the internal parts of a locking unit when a knob is set at a LOCK position according to an embodiment of the present invention;

FIG. 17 shows the internal parts of a locking unit when a knob is set at a LOCK position according to another embodiment of the present invention;

FIG. 18 shows the internal parts of a locking unit when a knob is set at the position of ACC, ON or START according to an embodiment of the present invention;

FIG. 19 shows the internal parts of an embodiment of a locking unit when the knob is turned from the position of FIG. 18 to the LOCK position to stop a vehicle from running;

FIG. 20 shows a hitching pin of a slider attached to an axle direction of a slider fixation part of a cam shaft in a LOCK position of a knob according to an embodiment of the present invention; and

FIG. 21 shows a lateral side of a hitching pin of a slider held onto a circumferential surface of a slider fixation part of a cam shaft when a knob is set to a position of ACC, ON or START in an embodiment of the present invention.

### DETAILED DESCRIPTION OF THE INVENTION

As shown in the figures, embodiments of a vehicle burglarproof device of the present invention comprises a fob 1 that is possessed by an authorized driver. The fob is a device, such as, a remote control unit, that electronically contains the identification information of the owner of the vehicle or of an authorized person to operate the vehicle. A locking unit 3 that locks and unlocks the ignition and steering column of the vehicle. Also included is a personal identification card (PIC) unit 5 for determining whether the driver is an authorized vehicle starter. The PIC communicates with the fob to start the vehicle and the fob communicates with the control locking device through the PIC. Also, a body control module (BCM) 9 is provided that relays the start and no start signal from the PIC 5 to the electronic control unit (ECU) 7.

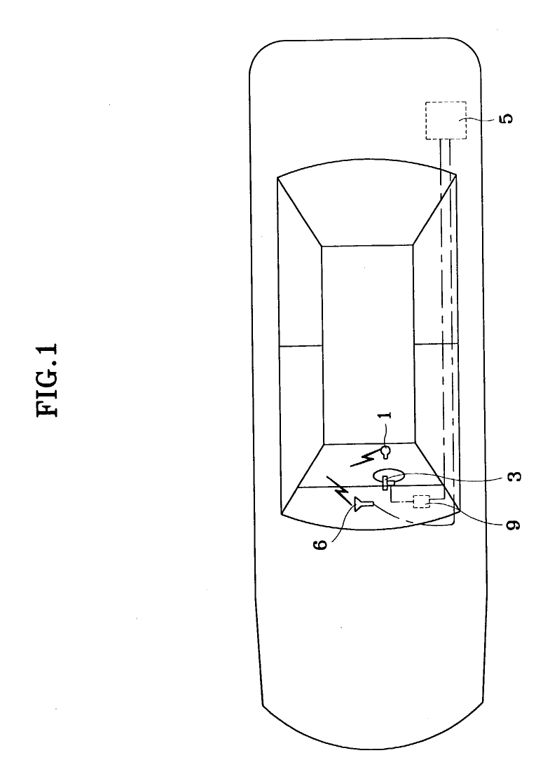

Referring to FIG. 1, the fob 1 uses wireless communication with the PIC unit 5 when a driver approaches or enters the vehicle. Furthermore, the fob runs off a battery so to be independent from the power supply of the vehicle. The PIC 5 has an antenna 6 on the interior of the vehicle for receiving communication from the fob. The BCM 9 is connected with the brake pedal through a brake pedal switch (not shown) for determining whether the brake pedal is depressed. The BCM 9 allows the PIC unit 5 to communicate with the fob 1, thereby unlocking the locking unit 3 only when a driver steps on the brake pedal. This provides the simultaneous function of preventing an abnormal sudden starting of the vehicle and abnormal start communications between the PIC unit 5 and fob 1.

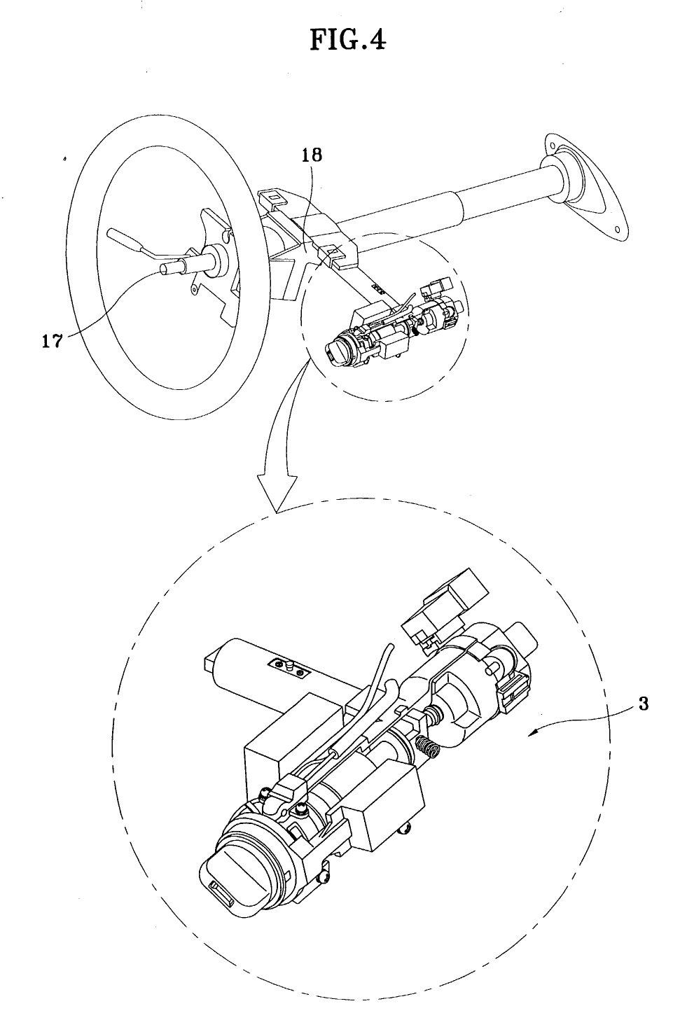

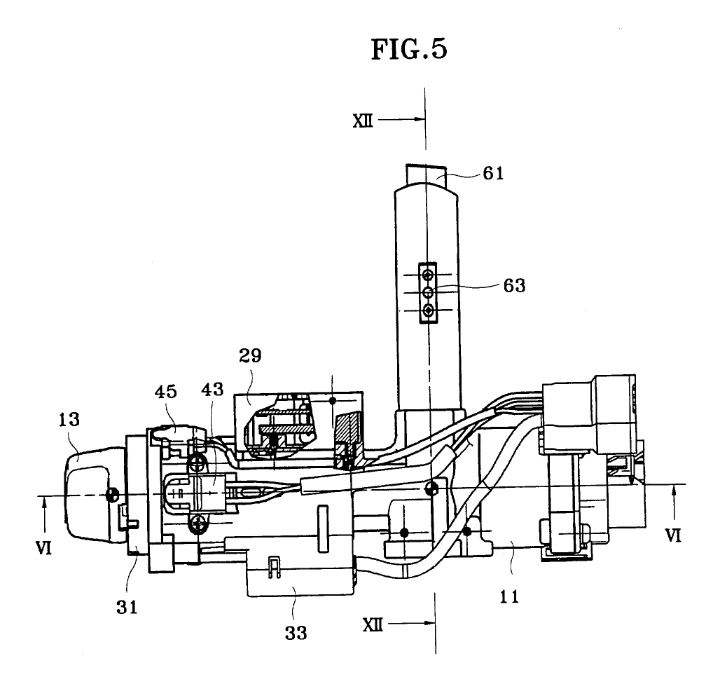

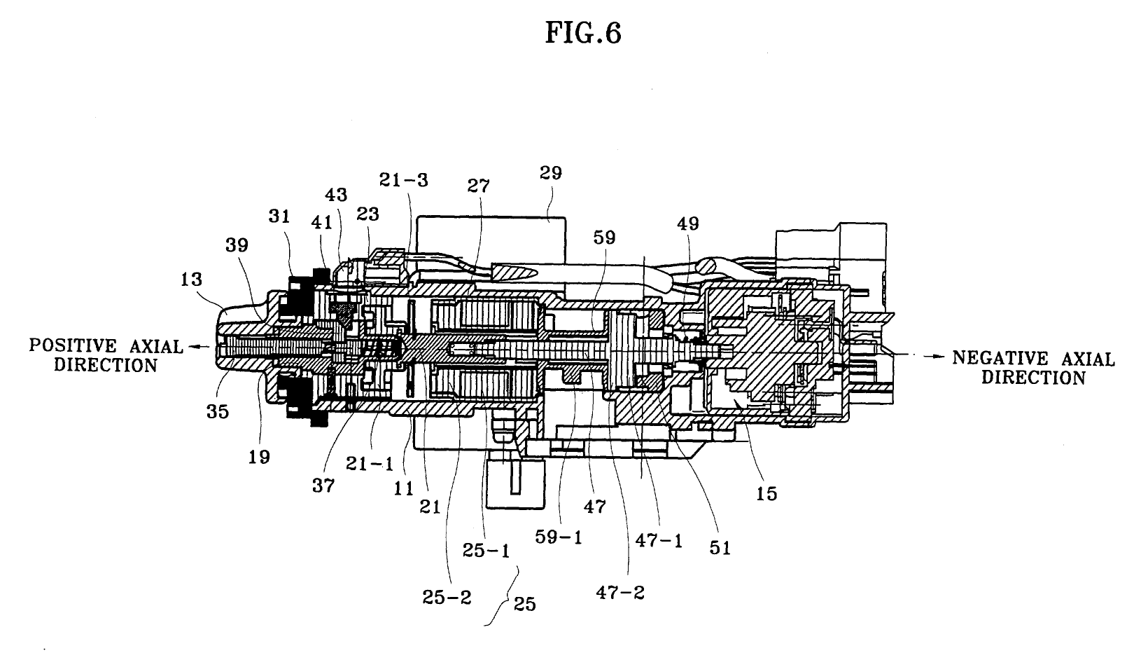

According to FIGS. 4-8, an embodiment of a locking unit 3 is constructed with a housing 11 installed at a steering column, a knob 13 installed at the housing 11 for accepting a driver's starting manipulations, and a rotation locking means. The rotation locking means controls inadvertent starting manipulations of the knob 13. Knob 13 controls a stating switch 15 that manipulates the starting power and the locking means for unlocking and locking the steering shaft 17. In a preferred embodiment, turning of the knob 13 turns to allow the starting and steering manipulation of the vehicle. The rotation locking means is made to determine the possibility of turning the knob 13 from the LOCK position to any one of either ACC, ON, START, or the like positions.

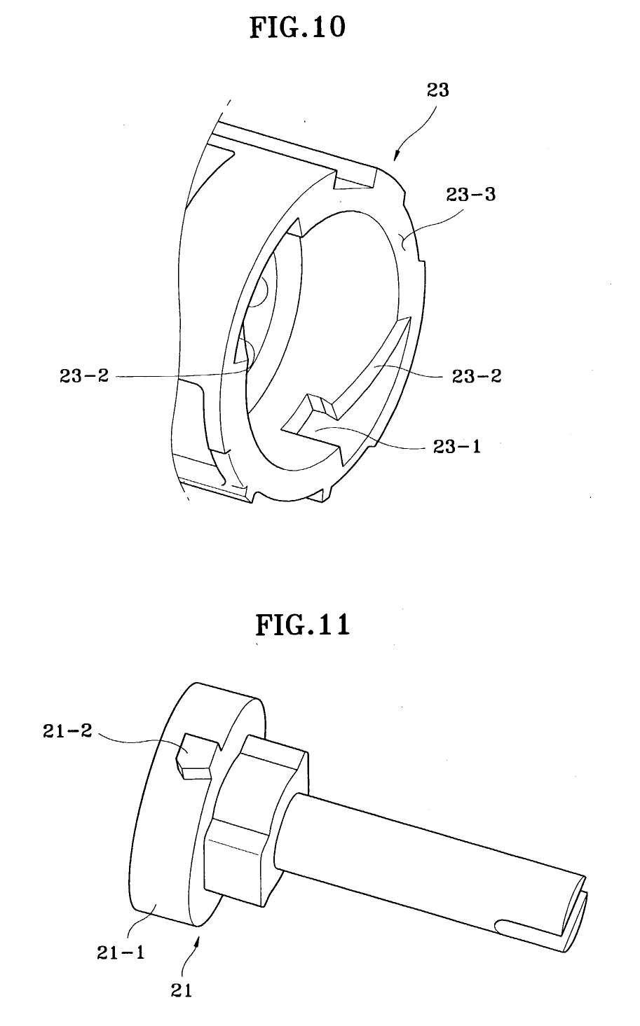

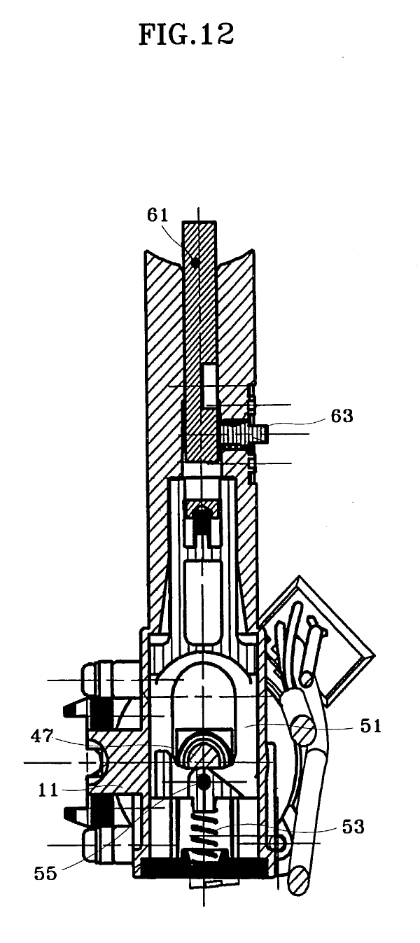

The rotation locking means includes a cylinder 19 connected with the knob 13 for providing at least a portion of a rotational axle of the knob 13. An actuator 21 (FIG. 11) conveys the rotational force to the circumferential direction of the cylinder 19 and slides in an axle direction with a circular sliding part 21-1, which has a plurality of external locking protruders 21-2. Hereinafter the rotational axle direction of the knob and the cylinder is referred to as the axial direction. A locking unit housing 23 (FIG. 10) is fixed at the internal side of the housing 11. It guides the external portion of the circular sliding part 21-1, with a locking groove 23-1 formed to restrict rotation of the actuator 21, as far as the locking protruder 21-2 moves in the axle direction. An electromagnet 25-1, for moving the actuator 21 to a negative axle direction (hereinafter, the direction moving from the knob 13 to the cylinder 19 is referred to as “a negative axle direction” and the reverse as “a positive axle direction”) to move the locking protruder 21-2 out of the locking groove 23-1 and enable the actuator 21 to rotate. A first spring 27 elastically supports the actuator 21 in the positive axle direction. A normal release means for moving the actuator 21, by the force of the electromagnet 25-1, to the position that allows for rotation in normal operation. Also, an emergent release means for moving the actuator 21, by the electromagnet 25-1, to the position, which allows for rotation by using the fob 1.

Hereinafter, ‘normal operation’ refers to the situation where the fob 1 is in normal communications with the PIC unit 5. On the other hand, the ‘emergent operation’ refers to situation where the battery of the fob 1 is no longer strong enough to produce a sufficient signal for communication with the PIC or when the wireless communication fails.

The normal operation means includes a fob 1 that includes information that identifies the user as authorized. The PIC unit 5 identifies the authorized user through communications with the fob 1. A solenoid controller 29 is included to control the electromagnet 25-1 according to the signal from the PIC unit 5.

The emergent release means includes a transponder 1-2 that is embedded in the fob 1. An insertion protruder 1-3 integrated in the fob and a fob insertion hole 13-1 formed in the knob 13 for insertion of the insertion protruder 1-3. Also included is a fob insertion sensing means for detecting the insertion of the insertion protruder 1-3 into the fob insertion hole 13-1 and an antenna coil 31. The antenna coil 31 is installed near the knob 13 for reading the data of the transponder 1-2. A demodulator 33 is also included for demodulating the data read by the antenna coil 31. The BCM 9 is included for driving the demodulator 33 and antenna coil 31 according to the signal of the fob insertion sensing means to perform a function of determining whether the information from the fob 1 corresponds with the information associated with the correct, authorized user. A PIC unit 5 for relaying information from the BCM 9 and a solenoid controller 29 for controlling the electromagnet 25-1 according to the signal of the PIC unit 5.

In use, when the fob 1 is in normal operations, the driver can start a vehicle due to the normal release means by simply rotating the knob 13 while stepping on the brake pedal. However, wireless communication of the fob fails, the fob 1 is inserted into the knob 13 just like a key to turn the knob 13 by the function of a conventionally used immobilizer to start the vehicle. Thus, in normal operation the fob 1 acts as a wireless key for starting the vehicle.

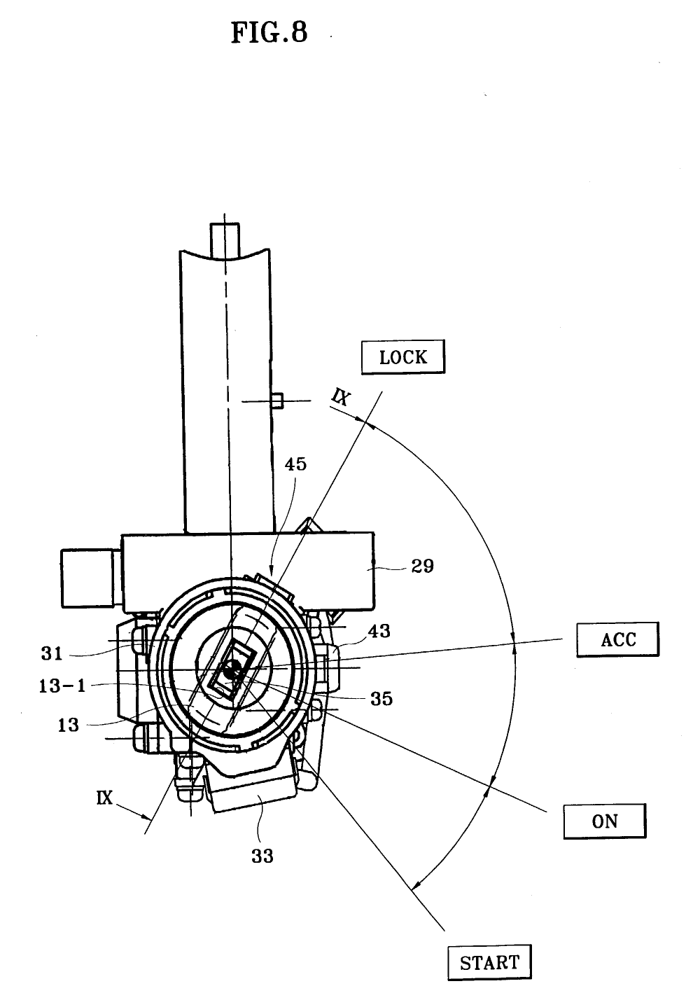

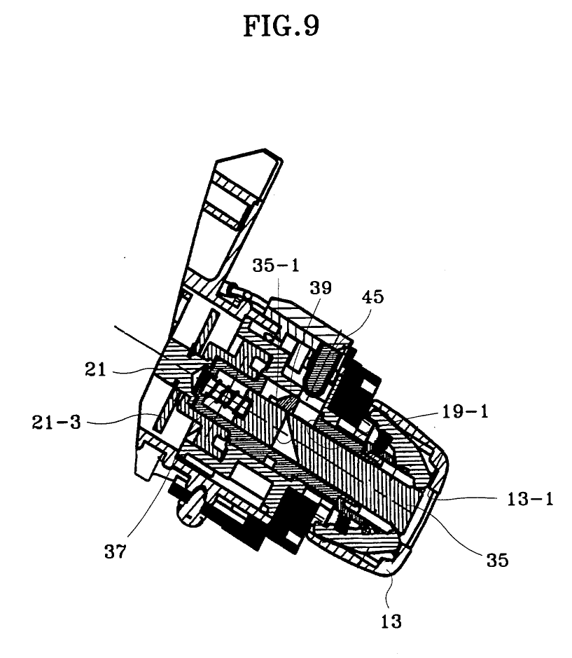

The fob insertion sensing means includes a key slider 35 (FIGS. 8 and 9) that receives the insertion protruder. 1-3 of the fob 1 by inserting it in the axial direction into the insertion hole 13-1. A key slider spring 37 that elastically supports the key slider 35. A first key-in slider 39 having a slanted surface to be pushed toward the axle direction by the key slider 35. A second key-in slider 41 having a slanted surface in contact with the slanted surface of the first key-in slider 39 such that it slides radially vertical with respect to the axle direction, according to the axial sliding motion of the first key-in slider 39. Also included is a key-in switch 43 whose contact point is switched by the radial motion of the key-in slider 41.

In a preferred embodiment the key slider 35 is made of a material that can transmit rays of light. As shown in FIG. 9, a bulb 45 is installed in the housing 11. The bulb 45 provides light to the key slider 35. An illuminating groove 19-1 is formed in the cylinder 19 to allow the bulb 45 to provide light for the lateral side of the key slider 35 when the knob is in a LOCK-position (FIG. 8). The key slider 35 has a reflecting surface 35-1 across from the bulb 45 to induce the light of the bulb 45 to the external side of the axle direction of the fob insertion hole 13-1. Therefore, in use, the light, provided through the key slider 35, helps the user find the position of the knob and the fob insertion hole 13-1.

The column locking means switches the state of rotation of a steering shaft 17 against a steering column 18. The column locking means includes a spiral slant part 23-2 formed in the locking unit housing 23. This allows a spiral sliding motion of the locking protruder 21-2 that moves a second movement section S2 in the negative axle direction by rotation after the actuator 21 slides a first movement section S1 in the negative axle direction by the force of the electromagnet 25-1. A permanent magnet 25-2 is included for magnetically fixing the plunger 21-3 of the actuator that has moved the second movement section S2. A cam shaft 47 having a cam 47-1 installed for conveying a rotational force to the actuator 21 and sliding in the axle direction. The first spring 27 is inserted between the cam shaft 47 and the actuator 21. A slider 51 is in contact with the cam 47-1 for forming a linear deviation to the direction of fixing the steering shaft 17 against the steering column 18 according to the rotation of the cam shaft 47. A second spring 49, for elastically supporting the cam shaft 47 to the positive axle direction. A slider spring 53 for elastically supports the slider 51 toward the cam 47-1 and steering shaft 17. A slider fixation part 47-2 is formed at the cam shaft 47. A hitching pin 55 and a hitching pin spring 57 are also included for elastically supporting the hitching pin 55 against the slider 51 for preventing movement to the steering shaft 17 when the slider fixation part 47-2 moves in the axle direction.

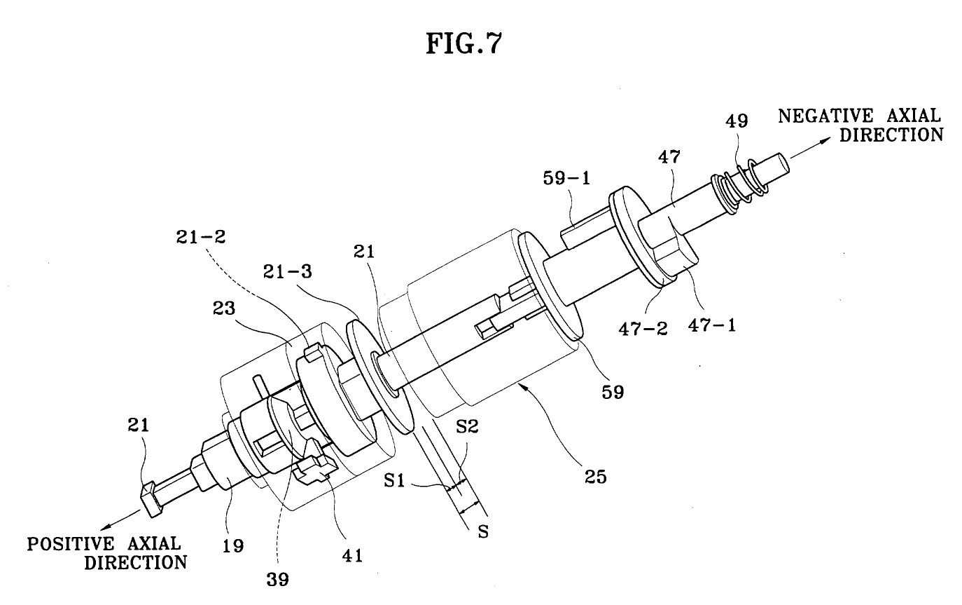

FIG. 7 shows the first movement section S1 defined as the interval that the actuator 21 is moves. The actuator 21 moves by the force of the electromagnet 25-1 after pressing down the first spring 27. It is then rotated by a rotational force conveyed from the knob 13 through the cylinder 19 after the locking protruder 21-2 is withdrawn from the locking groove 23-1. In FIGS. 7, 9, 10 and 11, the actuator 21 moves when the elastic force of the first spring 27 is overcome by the force of the electromagnet 25-1.

The second movement section S2 is the distance the actuator 21 moves from the end point of the first movement section S1 when the actuator 21. Thus, if the locking protruder 21-2 gets out of the spiral slant part 23-2, the actuator 21 cannot move toward the straight line any further. In other words, the second movement section S2 indicates a distance from an end point of the first movement section S1 to the end 23-3 of the negative axle direction of the locking part housing where the spiral slant part 23-2 of the locking part housing ends.

The interval where the locking protruder 21-2 makes a spiral sliding movement along the spiral slant part 23-2 relates to the state where the knob 13 turns from the LOCK position to the ACC position (FIG. 8). As described above, if the knob reaches the ACC position, the locking protruder 21-2 is held onto the end 23-3 of the negative axle direction where no power is supplied to the electromagnet 25-land the actuator 21 is not moved in the positive axle direction.

In an embodiment of the present invention, a permanent magnet 25-2 and electromagnet 25-1 are integrally packaged into a magnetic assembly 25. The permanent magnet 25-2 provides a magnetic force to pull the plunger 21-3 in a different direction than the electromagnet 25-1. This functions to maintain the state that the actuator 21 moves the second movement section S2 in the negative axle direction. Therefore, it is preferable that the plunger 21-3 become magnetically attached to the magnet assembly 25 while the actuator 21 moves the second movement section S2 completely to the negative axle direction.

FIG. 7 shows the second spring 49 elastically supported by the cam shaft 47 in the positive axle direction. The cam shaft 47 supports the first spring 27 and the actuator 21 in the positive axle direction. The movement of the cam shaft 47 on the positive axle direction is restricted by the magnet assembly 25 and a park lock rotator 59. It is preferable that the cam shaft 47 is made not to provide an excessive level of elasticity to the first spring 27 and the actuator 21 while it is in close contact with the magnet assembly 25 (fixed on the housing) via the park lock rotator 59.

In a preferable embodiment the elasticity of the second spring 49 is strong enough not to by compressed by the magnetic force of the electromagnet 25-1 and permanent magnet 25-2 while the cam shaft 47 is in close contact with the magnet assembly 25 via the park lock rotator 59. However, it is not so strong that manipulations by a driver of the knob 13 do not enable the actuator 21 and the cam shaft 47 to move the second movement section S2 in the negative axle direction.

The cam 47-1 is formed to move the slider 51 away from the steering shaft 17 as it is turned by the rotation of the cam shaft 47 to contact the slider 51.

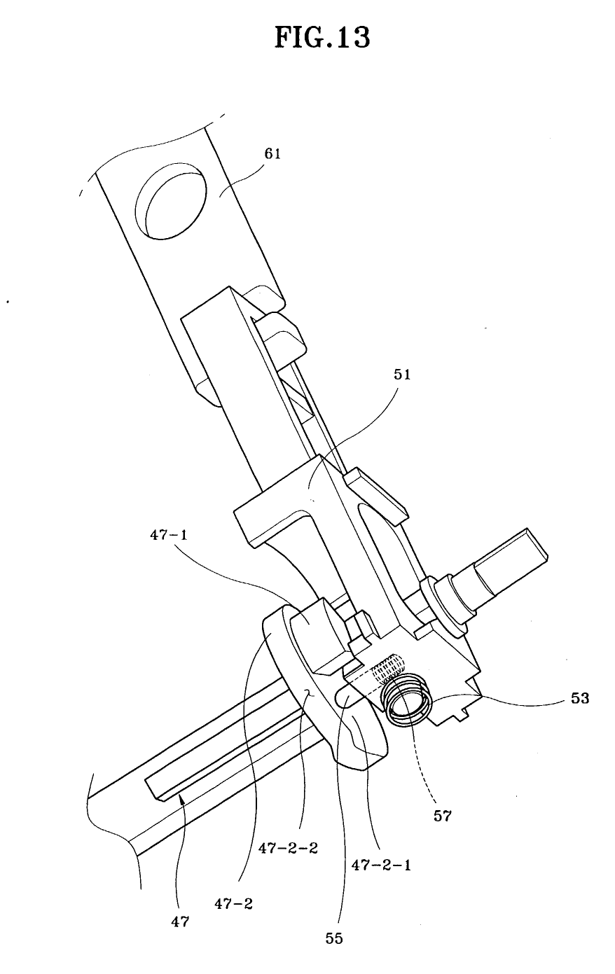

In an embodiment of the present invention, the slider 51 is constructed not to function in a direct contact or insertion in the steering shaft 17 or steering column 18 but to convey a linear deviation with a lock bolt 61, as seen in FIGS. 7 and 13. The lock bolt 61 and a mountain pin 63 prevent the housing 11 of the locking unit from being forcibly removed from the steering column 18. In use, the steering shaft 17 may only be unlocked by the slider 51.

Preferably the starting switch unit 15 is constructed in a rotary switch type. The connection of wires for starting the engine are preferably manipulated between the off and start position by the rotational force of the knob 13 conveyed via the cylinder 19, actuator 21, and cam shaft 47. The starting switch unit 15 is connected with the end of the negative axle direction of the cam shaft 47.

In another embodiment of the present invention, a key-in interlock means is included to stop the engine and lock the steering shaft 17 by rotating the knob 13 only when the gear change lever is in the parking range.

The key-in interlock means includes a park lock rotator 59 connected to make the cam shaft 47 slide linearly and convey a rotational force with a protruded park lock cam 59-1 to the circumference thereof. Also included is a park lock slider 65 connected with the gear change lever by an interlock cable that makes a straight sliding movement according to the selection of the gear change lever. It is installed in the housing 11 to switch the probability of rotation of the park lock rotator 59 by interference with the park lock cam 59-1.

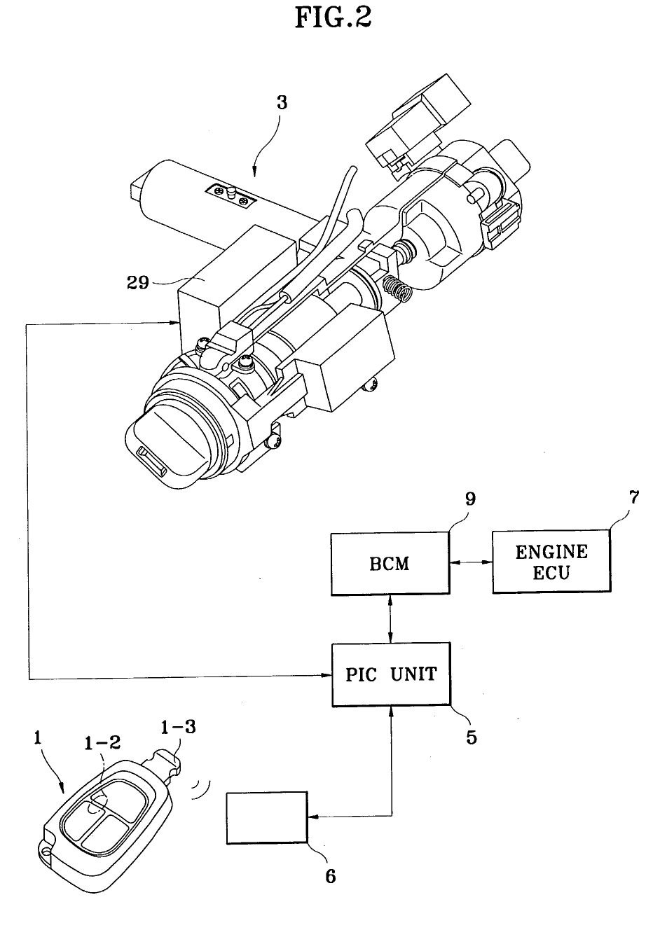

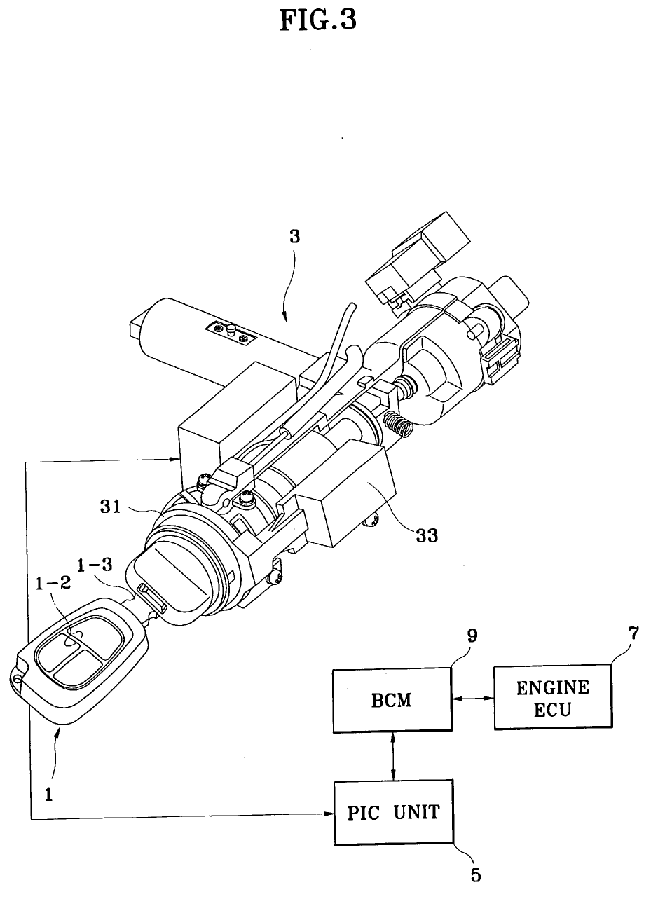

In reference to FIG. 2, a description of the operation the burglarproof device of the present invention will now be made. Initially, a driver holds the fob 1 and steps on the brake pedal of a vehicle. The BCM 9 then operates the PIC unit 5 with a signal sent by the brake pedal switch. The PIC unit 5 determines whether the fob 1 belongs to the authorized user. This communication is accomplished through the antenna 6. Upon confirmation that the fob 1 belongs to an authorized user, power is supplied to the electromagnet 25-1 through the solenoid controller 29. The actuator 21 then depresses the first spring 27 with the magnetic force of the electromagnet 25-1 and moves the first movement section S1. The locking protruder 21-2 is then released from the locking groove 23-1 and set to be in a rotatable state.

In this state, the driver can freely select ACC, ON, START, or the like by turning the knob 13. The PIC unit 5 then reports to the BCM 9 that the driver is authorized, and the BCM 9 sends a signal for allowing a normal start to the engine ECU 7. As a result, the driver can start the engine by manipulating the knob 13. The knob 13 must be turned to make the slider 51 slide to unlock the steering shaft 17.

However, if it is determined that the driver is not authorized through the communication with the fob 1, the PIC unit 5 does not operate the electromagnet 25-1 through the solenoid controller 29. Therefore, the locking protruder 21-2 of the actuator remains stuck in the locking groove 23-1, restricting rotation. This initially prevents the driver from turning the knob 13 to start the vehicle and release the steering column. If the knob 13 is turned by an artificially mechanical or electronic impact to the locking unit 3, or if wires from the starting switch unit 15 are removed to start the vehicle, the BCM 9 cannot receive a signal of identifying the authenticity of the driver from the PIC unit 5. Therefore, there is a failure to command normal operations to the engine ECU 7 to start the engine.

When the engine of the vehicle is turned off, the driver sets the gear change lever to a parking range and thereby rotates the knob 13 to the LOCK position. At this time, if the gear change lever is not set at the parking range, the knob 13 can be turned to the LOCK position by the key-in interlock means. The PIC unit 5 detects the parking range of the gear change lever and the LOCK position of the knob 13 to drive the electromagnet 25-1 through the solenoid controller 29. This moves the actuator in the positive axle direction by the elasticity of the first spring 27. Thereafter the locking protruder 21-2 is inserted into the locking groove 23-1 of the locking unit housing and the knob is locked at the LOCK position. At the same time, the slider 51 is moved to the steering shaft 17 by the effect of the cam shaft 47 and the slider spring 53 to lock the steering shaft 17. In such a state, power is not supplied to the electromagnet 25-1 and the locking state of the knob 13 is maintained by the mechanical integration of the actuator 21 and the locking unit housing 23.

When the driver inserts the insertion protruder 1-3 of the fob 1 into the fob insertion hole 13-1, the key slider 35 of the fob insertion sensing means operates the key-in switch 43 through the first and second key-in sliders 39 and 41 (FIG. 7). If the key-in switch is operated, the BCM 9 is also operated to drive the antenna coil 31 and the demodulator 33 to read the information of the transponder 1-2 and determine whether it matches the information of the authorized driver. This result is reported to the PIC unit 5, which, as described above, drives the solenoid controller 29 to make the rotation of the knob 3 possible through the electromagnet 25-1. Therefore, the driver can start the engine and drive the vehicle in the ways described above even when the driver is not in normal communications with the PIC unit 5 by using the fob 1. If there is no information available in the fob 1 of the knob 13 to prove that the user is authorized, the BCM 9 will notify such to the PIC unit 5 and the engine ECU 7. Thereby, rotation of the knob 13 is restricted.

In use, when the driver stops the vehicle the driver sets the gear change lever to the parking range and rotates the fob 1 to turn the knob 13 to the LOCK position and removes the fob 1. At this time, the PIC unit 5 detects the parking range of the gear change lever, the LOCK state of the knob 13, the removal of the fob 1, and then sends a signal to the solenoid control 29 to lock the actuator 21. The actuator 21 is locked by the locking unit housing 23 by the electromagnet 25-1 and the elasticity of the first spring 27. At the same time, this moves the slider 51 in the direction to lock the steering shaft 17. At this point, power is not supplied to the electromagnet 25-1 and the locking state of the knob 13 is maintained by a mechanical combination between the actuator 21 and the locking unit housing 23.

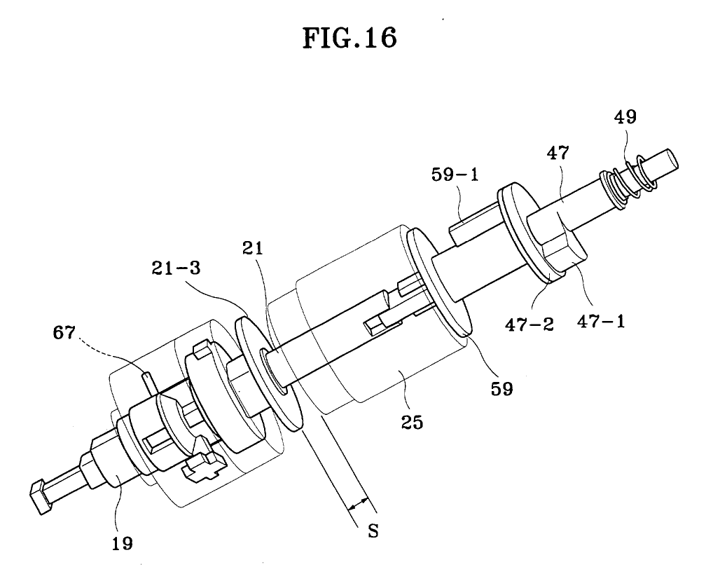

Hereinafter, the operational states of the locking unit will be described with reference to FIGS. 16 through 19.

FIG. 16 shows the structure of the locking unit 3 according to an embodiment of the present invention when the knob 13 is in the LOCK position. The cylinder 19, to which the rotational force of the knob 13 is conveyed, is in connection with the knob 13 and the actuator 21 of the locking unit housing 23. At the same time, a key slider 35 is slidably installed in the cylinder 19, to not rotate relative to the locking unit housing 23, by the hitching pin 67 and hitching groove 69, but to restrict movement in the axle direction. The key slider 35 is made to move the first key-in slider 39 in the axle direction. The movement of the first key-in slider 39 operates the key-in switch 43 when the second key-in slider 41 makes a radial movement.

The locking protruder 21-2 of the actuator 21 is inserted into the locking groove 23-1 of the locking unit housing. This eliminates rotation of the actuator 21. Furthermore, a plunger 21-3 is integrally installed on the actuator 21 that maintains a constant gap of S away from the magnetic assembly 25.

The cam shaft 47 makes a movement in the axle direction while the first spring 27 is inserted between the cam shaft 47 and the actuator 21. The cam shaft 47 is also installed to penetrate the magnetic assembly 25 while being able to convey the rotational force in the circumferential direction. The park lock rotator 59 is installed between the slider fixation part 47-2 and the magnetic assembly 25 to convey the rotational force of the cam shaft 47. Also, the second spring 49 is included at the end of the negative axle direction of the cam shaft 47. The starting switch unit 15 is installed to switch the contact point state of the starting wires according to the rotational state of the cam shaft 47.

The magnetic force that the permanent magnet 25-2 of the magnetic assembly supplies to the plunger 21-3 of the actuator is smaller than the elasticity of the first spring 27 or that of the second spring 49. The actuator 21 cannot be moved to the negative axle direction only by the magnetic force of the permanent magnet 25-2. Therefore, the rotation of the actuator 21 is continuously restricted by the locking unit housing 23.

The cam 47-1 of the cam shaft continues to maintain the steering shaft 17 in a locked position as the slider 51 is moved to the steering shaft 17 by the elasticity of the slider spring 53 (FIG. 13).

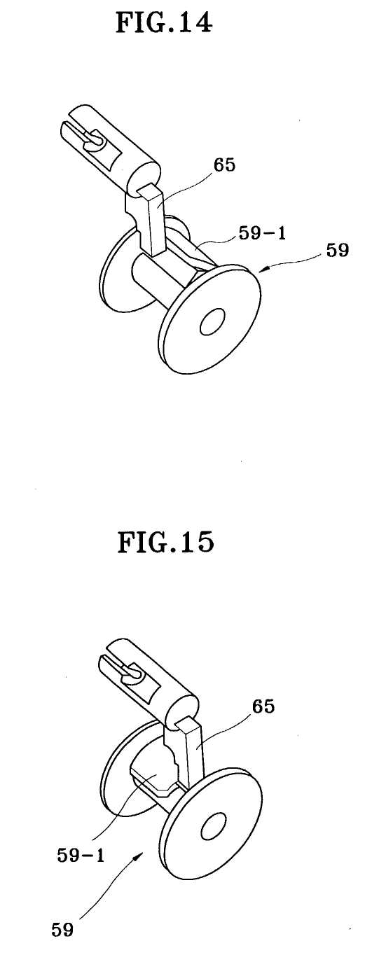

As the park lock slider 65 (FIGS. 14 and 15) does not interfere with the rotational direction of the park lock cam 59-1 as it does not block the rotation of the park lock rotator 59. Meanwhile, the park lock cam 59-1 is made to restrict the linear sliding of the park lock slider 65. As a result, it is the gear change lever is restricted from movement once in the parking range.

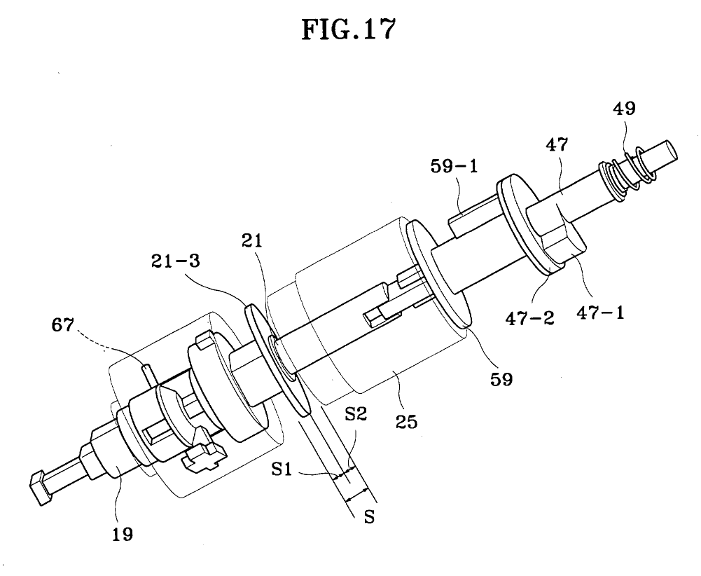

FIG. 17 shows the knob 13 still set at the LOCK position. At this time, the PIC unit 5 operates the electromagnet 25-1 through the solenoid controller 29. In other words, the user is identified as an authorized driver, so that the knob 13 is unlocked for rotation. The electromagnet 25-1 supplies a magnetic force in the positive direction under the control of the solenoid controller 29. In other words, as the electromagnet 25-1 can provide a magnetic force for the negative or positive axle directions. The electromagnet 25-1 provides a magnetic force of pulling the actuator 21 in the negative axle direction in addition to the magnetic force of the permanent magnet 25-2. However, in the state which will be described below, the electromagnet 25-1 provides a magnetic force in the opposite direction to offset the magnetic force of the permanent magnet 25-2. The actuator 21 and the cam shaft 47 get to move to the positive axle direction by the elasticity of the second spring 49.

The actuator 21 shrinks the first spring 27 with the magnetic force of the electromagnet 25-1 added to that of the permanent magnet 25-2. This moves the first movement section SI in the negative axle direction, displacing the locking protruder 21-2 out of the locking protruder 23-1. As a result, the actuator 21 allows the knob 13 to be rotated by the rotational force conveyed through the cylinder 19. In a preferred embodiment, the elasticity of the first spring 27 should be greater than the magnetic force of the permanent magnet 25-2 affecting the LOCK position of the plunger 21-3, but smaller than the magnetic force of the electromagnet 25-1 added to that of the permanent magnet 25-2.

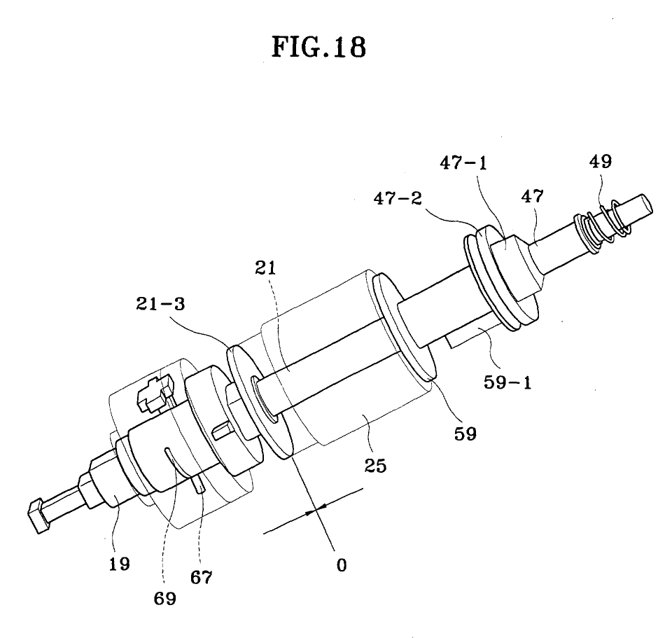

FIG. 18 shows the components of an embodiment of the present invention in association with the knob 13 being rotated to the ACC, ON, or START position by the driver.

When the driver rotates the knob 13, the locking protruder 21-1 of the actuator 21 makes a spiral sliding movement along the spiral slant part 23-2 of the locking unit housing. As a result, the actuator 21 rotates to move the second movement section S2 in the negative axle direction, thereby allowing the plunger 21-3 to make contact with the magnetic assembly 25.

The movement of the actuator 21 in the negative axle direction is made only while the knob 13 turns from the LOCK position to the ACC position. At the ON or START position the actuator 21 is simply rotated while the plunger 21-3 is in contact with the magnetic assembly 25.

While the cam shaft 47 is rotated by the rotational force conveyed from the actuator 21, the cam 47-1 makes the slider 51 move away from the steering shaft 17 to unlock the steering shaft 27. At this time, the starting switch unit 15 is rotated and manipulated to freely select the ACC, ON or START state.

The park lock rotator 59 is then rotated to turn to a position where the park lock cam 59-1 does not disturb the linear slidings of the park lock slider 65. As a result, the driver can freely manipulate the gear change lever. Therefore, the driver can drive the vehicle. After driving the vehicle, the driver turns the knob 13 to the LOCK position to stop the engine from running and sets the gear change lever to the parking range. It is because the gear change lever is set at the parking range to prevent the park lock cam 59-1 of the park lock rotator 59 from interfering with the park lock slider 65 and to rotate the cylinder 19, actuator 21, and cam shaft 47 connected with the knob 13.

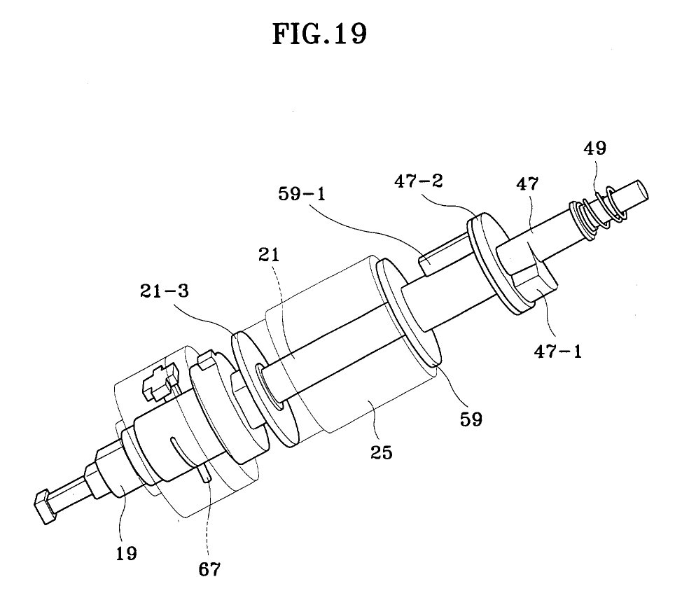

FIG. 19 shows the components of an embodiment of the present invention when the driver sets the knob 13 to the LOCK position to turn off the engine.

The rotational force of the knob 13 is connected to the starting switch unit 15 through the cylinder 19, actuator 21, and cam shaft 47. The starting switch unit 15 is set at a position where the engine is turned off, but the plunger 21-3 is closely attached to the magnetic assembly 25. At this time, the cam shaft 47 is at the position shown in FIG. 18, where the cam shaft 47 is not moved in the positive axle direction.

As described above, the cam shaft 47 is rotated to the LOCK position by the rotation of the knob 13, but not moved in the positive axle direction. In other words, the magnetic force affecting the permanent magnet 25-2 and the plunger 21-3 significantly increases as the distance between them decreases. When the plunger 21-3 is tightly attached to the magnetic assembly 25 by the magnetic force of the permanent magnet 25-2, its magnetic force is greater than the elasticity of the second spring 49.

At the aforementioned state, the cam shaft 47 is only rotated to the phase of the LOCK position and placed at the same positions of ACC, ON, and START positions to the axle direction. At the aforementioned state, the slider 51 does not lock the steering shaft 17. In other words, if the vehicle is started by using the fob 1 manually, the steering shaft 17 should not be locked before the driver takes the fob 1 out of the knob 13.

As described above, the PIC unit 5 detects the parking range of the gear change lever, the LOCK position of the knob 13, and the removal of the fob 1 from the knob 13. Thereafter, the PIC unit 5 operates the solenoid controller 29 to lock the knob 13 and the steering shaft 17.

If the PIC unit 5 detects the parking range status of the gear change lever and the LOCK position of the knob in the normal operations, it can operate the solenoid controller 29 to lock the knob 13 and the steering shaft 17. Therefore, the condition illustrated in FIG. 19 is only temporary. At this time, if the driver sets the knob 13 to the LOCK position, the engine turns off and almost simultaneously the steering shaft 17 and the knob 13 lock.

The operation of the PIC unit 5 that turns on the solenoid controller 29 to lock the knob 13 and the steering shaft 17 offsets the force of the permanent magnet 25-2 pulling the plunger 21-3 in the negative axle direction. This occurs by reversing the direction of the magnetic force of the electromagnet 25-1. Thus, the cam shaft 47 can be moved to the positive axle direction by the elasticity of the second spring 49. Besides, the gradual expansion of the first spring 27 inserts the actuator 21 into the locking unit housing 23, thereby making the locking protruder 21-2 inserted into the locking groove 23-1.

Moreover, as the cam shaft 47 moves in the positive axle direction, the hitching pin 55 held onto the slider fixation part 47-2 of the cam shaft 47 becomes free to the; moving direction of the slider 51. This brings about a linear deviation toward the steering shaft 17 by the elasticity of the slider spring 53. Therefore, the steering shaft 17 is locked at the steering column 18 by the lock bolt 61.

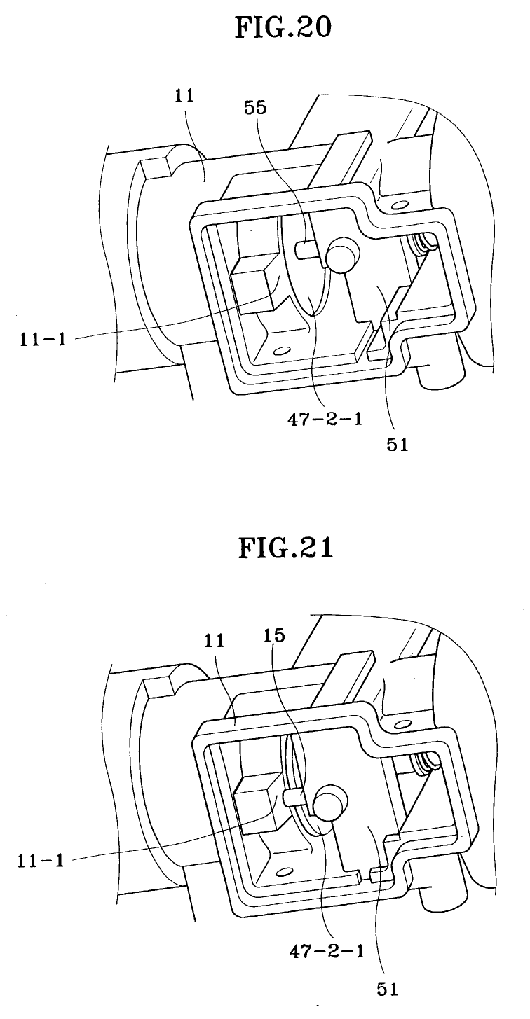

Referring to FIGS. 20 and 21, the operations of the hitching pin 55 of the slider 55 and the slider fixation part 47-2 of the cam shaft will be described. At the LOCK position of the knob 13 the hitching pin 55 is attached to the axle direction surface 47-2-1 of the slider fixation part 47-2 by the hitching pin spring 57. The hitching pin spring 57 is inserted between the slider 51 and the slider fixation part 47-2. When the knob 13 is turned to the ACC status, the hitching pin 55 compresses the hitching pin spring 57 and moves into the slider 51 by the movement of the cam shaft 47 in the negative axle direction. Then, if the slider 51 is moved by the cam 47-1 such that the hitching pin 55 gets out of the axle direction surface 47-2-1 of the slider fixation part, the hitching pin 55 is protrudes and touches the wall surface 11-1 of the housing 11 by the elasticity of the hitching pin spring 57. The protruded state of the hitching pin 55 makes the lateral surface of the hitching pin 55 connect with the circumferential surface 47-2-2 of the slider fixation part. As a result, if the cam shaft 47 is set at the LOCK position, the cam 47-1 of the cam shaft can fix the slider 51 even if the cam 47-1 of the cam shaft no longer supports the slider 51. When the PIC unit 5 operates the solenoid controller 29 to move the cam shaft 47 in the positive axle direction, the hitching pin 55 releases and moves the slider 51 in the direction of locking the steering shaft 17.

Furthermore, the operations described above makes the cam shaft 47 move a stroke of the second movement section S2 and lock the steering shaft 17. The actuator 21 moves the second and first movement sections S2 and S1, respectively, at the same time to lock the knob 13.

The foregoing description of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A vehicular burglarproof device, comprising:
a fob configured to contain identification data for allowing starting and unlocking of a vehicle steering column;
a locking unit that switches the probable or improbable states of the starting and steering manipulations of a vehicle;
a personal identification card (PIC) unit that determines whether the driver is authorized through communications with said fob and controls said locking unit to thereby make the starting and/or steering manipulations of the vehicle; and
a body control module (BCM) that provides the positive or negative permit of starting the vehicle to an engine electronic control unit (ECU) according to the signal of said PIC unit.

2. The device as defined in claim 1, wherein the locking unit comprises:
a housing installed near a steering column;
a knob installed at said housing configured for rotational manipulation;
rotation locking means for switching the probable or improbable state of the rotational manipulations of said knob;
a starting switch unit for switching starting power by rotational manipulations of said knob; and
column locking means for switching the probable or improbable state of the rotation of a steering shaft by rotational manipulations of said knob.

3. The device as defined in claim 2, wherein said rotation locking means comprises:
a cylinder connected with said knob for playing a role as a rotational axle of said knob;
an actuator installed to convey the rotational force to the circumferential direction of said cylinder and to slide toward an axle direction with a circular sliding part which has a plurality of locking protruders externally;
a locking unit housing fixed at the internal side of said housing for guiding the external portion of said circular sliding part with a locking groove formed to restrict rotation of said actuator as far as said locking protruder is moved in the axle direction;
an electromagnet for moving said actuator in a negative axle direction to get said locking protruder out of a locking groove and make said actuator possible for rotation;
a first spring elastically supporting said actuator in the positive axle direction;
normal release means for automatically moving said actuator with said electromagnet to the probable state of rotation in normal operations; and
emergency release means for moving said actuator with said electromagnet to the probable state of rotation by using said fob in emergency.

4. The device as defined in claim 3, wherein said actuator further comprises a plunger for receiving magnetic force from said electromagnet.

5. The device as defined in claim 3, wherein said normal release means comprises:
a fob embedding information to identify an authorized user;
the PIC unit that identifies the authorized user through communications with said fob; and
a solenoid controller that controls said electromagnet according to the signal of said PIC unit.

6. The device as defined in claim 3, wherein said emergency release means comprises:
a transponder embedded in said fob;
an insertion protruder integrated in said fob;
a fob insertion hole formed in said knob for insertion of said insertion protruder of said fob;
fob insertion sensing means for detecting the insertion of said insertion protruder into said insertion hole;
an antenna coil installed near said knob for reading the data of said transponder;
a demodulator for demodulating the data read by said antenna coil;
the BCM for driving said demodulator and said antenna coil according to the signal of said fob insertion sensing means to additionally perform a function of determining whether the information of said fob belongs to the authorized user;
a PIC unit for getting information from said BCM; and
a solenoid controller for controlling said electromagnet according to the signal of said PIC unit.

7. The device as defined in claim 6, wherein said fob insertion sensing means comprises:
a key slider that slides toward the axle direction by an insertion protruder of said fob when said key slider is inserted into said fob insertion hole;
a key slider spring that elastically supports said key slider;
a first key-in slider having a slant surface that is pushed toward the axle direction by said key slider;
a second key-in slider having a slant surface in contact with the slant surface of said first key-in slider that slides radially vertical to the axle direction, according to the axial sliding motion of said first key-in slider; and
a key-in switch whose contact point is switched by the radial motion of said key-in slider.

8. The device as defined in claim 7, wherein said key slider is made of a material that can transmit rays of light; wherein said housing includes a bulb to provide light to said key slider; and wherein the cylinder includes an illuminating groove to allow said bulb to provide light for the lateral side of said key slider when said knob is in the LOCK state.

9. The device as defined in claim 8, wherein said key slider has a reflecting surface across from said bulb to induce the light of said bulb to the external side of the axle direction of said fob insertion hole.

10. The device as defined in claim 3, wherein said column locking means comprises:
a cam shaft having a cam installed for receiving rotational force from said actuator;
a slider in contact with said cam for forming a straightly changing position linear deviation to the direction of fixing said steering shaft against said steering column according to the rotation of said cam shaft; and a slider spring elastically supporting said slider toward said cam and steering shaft.

11. The device as defined in claim 4, wherein said column locking means comprises:
a spiral slant part formed in said locking unit housing for spiral sliding motion of said locking protruder in order for said actuator to move a second movement section in the negative axle direction by rotation after said actuator slides a first movement section straightly in the negative axle direction with the force of said electromagnet;
a permanent magnet for magnetically fixing the plunger of said actuator that has moved the second movement section;
a cam shaft having a cam installed for conveying the rotational force to said actuator and to the circumference and to slide in the axle direction while said first spring is inserted between said cam shaft and said actuator;
a second spring for elastically supporting said cam shaft in the positive axle direction;
a slider in contact with said cam for forming a straightly changing position linear deviation to the direction of fixing said steering shaft against said steering column according to the rotation of said cam shaft;
a slider spring for elastically supporting said slider toward said cam and said steering shaft;
a slider fixation part formed at the cam shaft; and
a hitching pin of said slider and a hitching pin spring for elastically supporting said hitching pin against said slider for preventing said slider from moving to said steering shaft according to the movement state of said slider fixation part in the axle direction.

12. The device as defined in claim 11, wherein said starting switch unit is installed for being operated by the rotational force of said knob conveyed through said actuator and said cam shaft.

13. The device as defined in claim 11, wherein key-in interlock means additionally comprises rotating said knob to turn off the engine and lock said steering shaft only when the gear change lever is set at the parking range.

14. The device as defined in claim 13, wherein said key-in interlock means comprises:
a park lock rotator connected to make said cam shaft slide straightly in the middle thereof and convey rotational force with a park lock cam protruded to the circumference; and
a park lock slider connected with said gear change lever by an interlock cable to make a straight sliding movement according to the selected range of said gear change lever and installed in said housing to switch the possibility of rotation of said park lock rotator by interference with said park lock cam.

15. A vehicle burglarproof assembly, comprising;
a remote encrypted with identification information for authorizing starting of the vehicle and unlocking of a steering column of the vehicle;
a personal identification unit configured to communicate through wireless communication with said remote to initiate the starting and unlocking of the vehicle;
a body control module configured to receive a signal from said personal identification unit wherein said body control module is in communication with a brake lever of the vehicle such that when the brake lever is depressed by a driver said body control module continues the starting and unlocking sequence;
a locking unit coupled near the steering column of the vehicle and configured to physically lock the steering column from rotation and lock a knob used for starting of the vehicle; and
an electronic control unit configured to start an engine of the vehicle.

16. The assembly of claim 15, wherein said remote comprises:
a protruding portion on said remote configured to be inserted into a receiver on said locking unit;
a detector embedded within said locking unit configured to communicate with said body control module and said personal identification unit;
a transponder embedded within said remote configured to communicate with said detector; and
a solenoid controller for controlling said locking unit in response to a signal from said personal identification unit.
